(19) United States
(12) Patent Application Publication
(10) Pub. No.: US 2026/0254128 A1
(43) Pub. Date: Aug. 27, 2026

(54) ANTENNA STRUCTURE

(71) Applicant: SENAO NETWORKS, INC., TAOYUAN (TW)

(72) Inventor: Jhih-Hao DUAN, TAOYUAN (TW)

(21) Appl. No.: 19/336,800

(22) Filed: Sep. 23, 2025

(30) Foreign Application Priority Data
Feb. 21, 2025 (TW) 114106550

(51) Int. Cl. H01Q 19/10; H01Q 9/20

(52) U.S. Cl. CPC H01Q 19/108; H01Q 9/20

(57) ABSTRACT

An antenna structure includes a ground terminal, a feed point, and multiple antenna units. The feed point is arranged on a central region of the antenna structure. The multiple antenna units are arranged on at least one surface of the antenna structure. Each of the multiple antenna units includes an extension portion and a radiation portion, respectively. Each extension portion symmetrically extends from the central region toward an external direction respectively. The extension portion form a corner with the radiation portion, and the radiation portion to extend to a side relative to the external direction. A few of the extension portions include an inner section and an outer section, the inner section forms an included angle with the external direction, the outer section is parallel to the external direction, and the antenna structure generates a radiation pattern that is asymmetrical relative to the feed point.

This application claims priority to Taiwan Patent Application No. 114106550 filed on Feb. 21, 2025, which is hereby incorporated by reference in its entirety.

### BACKGROUND OF THE INVENTION

The present invention relates to an antenna structure. More specifically, the present invention relates to an antenna structure that switches radiation patterns.

The conventional Alford loop antenna 1 has a plurality of antenna branches, and these antenna branches are symmetrically arranged to produce a symmetrical radiation pattern, as shown in FIG. 1. Specifically, the Alford loop antenna 1 has four antenna branches (i.e., 10A, 10B, 10C, 10D) extend outward from a feed point FP located at a center location, respectively. Since the current directions of the antenna branches 10A, 10B, 10C, and 10D are all symmetrically collected at the center location of the antenna, the radiation energy at the center of the radiation pattern generated by the antenna branches 10A, 10B, 10C, and 10D will be canceled out, thereby generating a null point (i.e., Null) in the radiation pattern (i.e., the concaved point of the radiation pattern). In other words, the antenna generates a radiation pattern in which the signal is stronger at the surrounding locations but weaker at the center, as shown in FIG. 2.

This type of antenna is suitable for installation on the ceiling, (i.e., ceiling-mounted), where the surrounding locations of the radiation pattern (where the signal is stronger) may radiate to the entire indoor space, and only the signal directly below the antenna will be weak. However, if the antenna is installed on a wall (i.e., wall-mounted), the center of its radiation pattern will have a null point, the indoor space pointed by the center of the antenna will have poor reception of signal, and the quality and stability of communication is affected. In view of this, there is an immense requirement for artisans in the technical field of the present invention to solve the problem of poor signal at the center of the radiation patterns caused by the currents in the antenna branches canceling each other out.

### SUMMARY OF THE INVENTION

In order to overcome the above technical problems, the present invention provides an antenna structure. The antenna structure includes a ground terminal, a feed point and a plurality of antenna units. The feed point is disposed in a central region of the ground terminal. The antenna units are respectively disposed on at least one surface of the antenna structure. Each of the antenna units includes an extension portion and a radiation portion, each of the extension portions extends generally symmetrically from the central region towards an external direction, the extension portions respectively form a corner with the radiation portion, and each of the radiation portions extend to one side relative to the external direction. A few of the extension portions include an inner section and an outer section, respectively, the inner section forms an included angle with the external direction, and the antenna structure generates a radiation pattern that is asymmetrical with respect to the feed point.

In order to overcome the above technical problems, the present invention provides another antenna structure. The antenna structure includes a ground terminal, a feed point, a plurality of antenna units and a plurality of switching units. The feed point is disposed in a central region of the ground terminal. The antenna units are respectively disposed on at least one surface of the antenna structure, and the antenna units each includes an extension portion and a radiation portion, each of the extension portions extends generally symmetrically from the central region towards an external direction, the extension portions respectively form a corner with the radiation portions, and each of the radiation portions extend to one side relative to the external direction. The switching units are respectively coupled to the extension portion of each antenna unit. The switching units are configured to selectively turn off a few of the antenna units to generate a radiation pattern that is asymmetrical with respect to the feed point.

As mentioned above, the present invention can improve the problem of poor signals in the center of the radiation pattern of a conventional antenna structure by arranging a few of the antenna units in the antenna structure to have an included angle so that the radiated energy at the center of the radiation pattern generated by the antenna structure will not significantly cancel each other out. In addition, the present invention can also selectively turn off or turn on the antenna units through the switching unit, which can flexibly prevent the radiation energy at the center of the radiation pattern generated by the antenna structure from canceling each other out significantly. Therefore, the antenna structure provided by the present invention can effectively improve the communication quality and stability of the center of the antenna.

The above content is not intended to limit the present invention, but only briefly describes the technical problems that can be solved by the present invention, the technical means that can be adopted, and the technical effects that can be achieved, so that a person having ordinary skill in the art can have a preliminary understanding of the present invention. The embodiments of the present invention will be described below in conjunction with the drawings.

### BRIEF DESCRIPTION OF DRAWINGS

FIG. 1 illustrates a schematic view of a conventional Alford loop antenna structure.

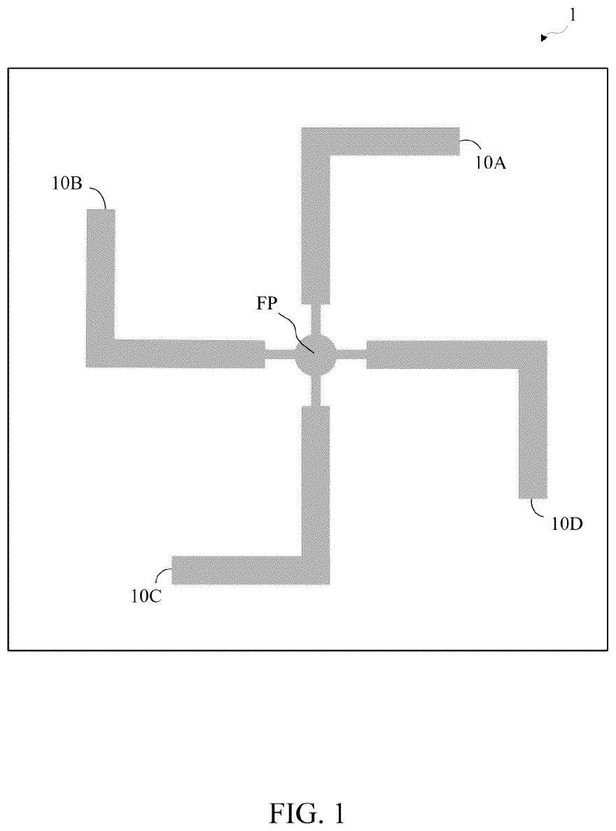

FIG. 2 illustrates a schematic view of the radiation pattern of a conventional Alford loop antenna structure.

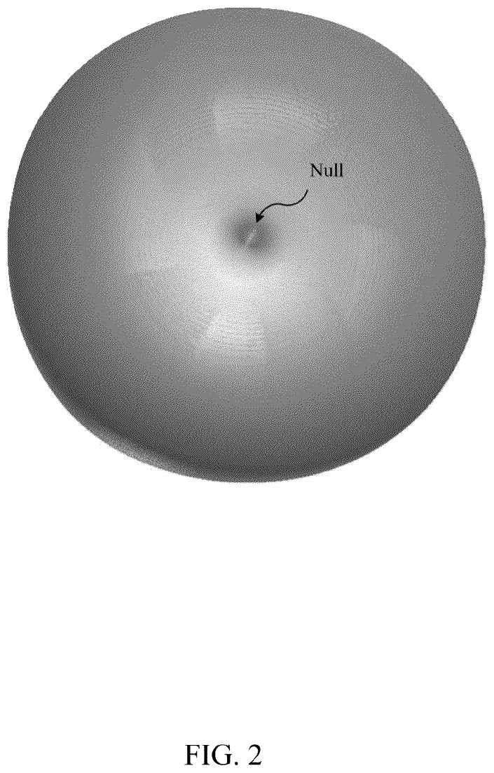

FIG. 3 illustrates a schematic view of an antenna structure with an antenna unit having an included angle according to certain embodiments of the present invention.

FIG. 4 illustrates a schematic view of the radiation pattern of an antenna structure with an antenna unit having the included angle according to certain embodiments of the present invention.

FIG. 5 illustrates a schematic view of an antenna structure with two antenna units having an included angle, according to certain embodiments of the present invention.

FIG. 6 illustrates a schematic view of the radiation pattern of an antenna structure with two antenna units having the included angle, according to certain embodiments of the present invention.

FIG. 7 illustrates a schematic view of an antenna structure with three antenna units having an included angle according to certain embodiments of the present invention.

FIG. 8 illustrates a schematic view of the radiation pattern of an antenna structure with three antenna units having an included angle according to certain embodiments of the present invention.

FIG. 9 illustrates a schematic view of an antenna structure with a switching unit according to certain embodiments of the present invention.

FIG. 10 illustrates a schematic view of an antenna structure with a switching unit according to certain other embodiments of the present invention.

FIG. 11 illustrates a schematic view of the radiation pattern of an antenna structure with the switching unit according to certain other embodiments of the present invention.

### DETAILED DESCRIPTION OF THE INVENTION

In the following description, the present invention will be described below through multiple embodiments, but these embodiments are not intended to limit the present invention to only be implemented according to the operations, environments, applications, structures, processes or steps described herein. Elements not directly related to the present invention are not shown in the drawings, and may be implicit in the drawings. In the drawings, the size of each element and the proportions between each element are only examples and are not used to limit the present invention. Unless otherwise specified, in the following content, the same (or similar) element symbols may correspond to the same (or similar) elements. In practical situations, the number of each element described below may be one or more unless otherwise specified.

The terms used in this disclosure are only used to describe the embodiments and are not intended to limit the present invention. The singular form “a” and “an” are intended to include the plural form as well, unless the context clearly indicates otherwise. Words such as “comprise” and “include” indicate the presence of stated features, integers, steps, operations, elements and/or components, but do not exclude the presence of one or more other features, integers, steps, operations, elements, components and/or combinations of the foregoing. The term “and/or” includes any and all combinations of one or more of the associated listed items.

Unless the context indicates otherwise, the descriptions “A”, “B”, “C”, “D”, or “a”, “b”, “c”, “d”, etc. are only for the purpose of distinguishing the elements referred to after them, and such descriptions should not be understood to mean that these elements are sequential.

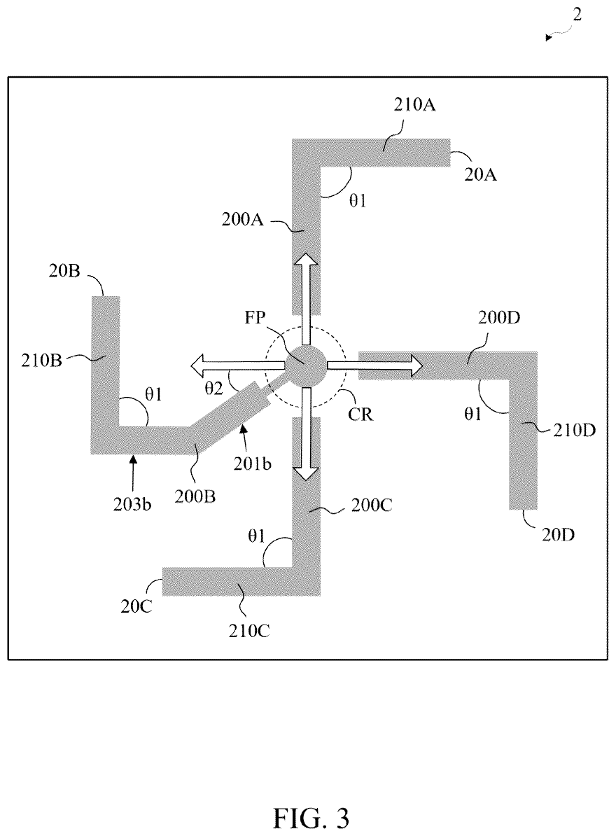

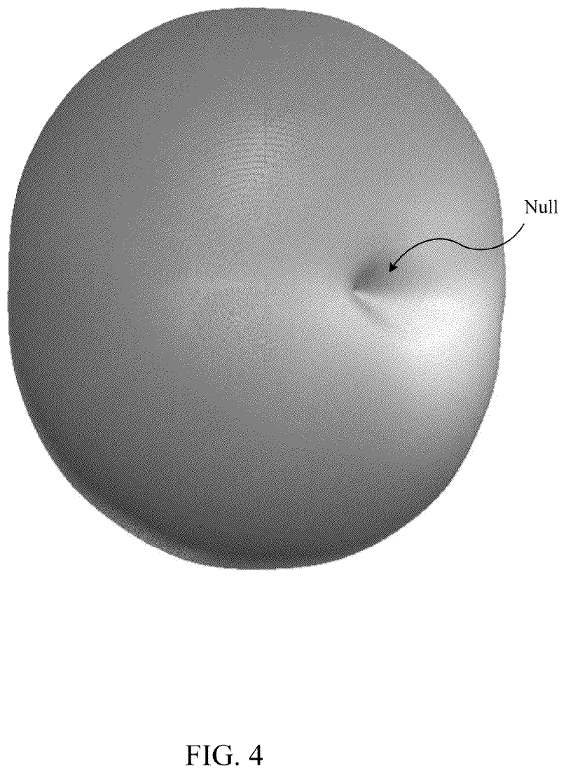

FIG. 3 illustrates a schematic view of an antenna structure 2 with an antenna unit having an included angle according to certain embodiments of the present invention. FIG. 4 illustrates a schematic view of the radiation pattern of an antenna structure 2 with the antenna unit having the included angle according to certain embodiments of the present invention. However, the contents shown in FIGS. 3 and 4 are only provided to illustrate embodiments of the present invention and should not be interpreted as any limitation to the present invention.

As shown in FIG. 3, in this embodiment, the antenna structure 2 may include a ground terminal G, a feed point FP, and a plurality of antenna units (also referred to as “antenna branches”). The feed point FP can be disposed in a central region of an upper surface of the antenna structure 2 (i.e., the dotted circle around the feed point FP), and the ground terminal G can be disposed on the lower surface of the antenna structure 2, as represented by a dashed line. In some embodiments, the feed point FP may be disposed in the central region of the lower surface of the antenna structure 2, and the ground terminal G may be disposed in the central region of the upper surface of the antenna structure 2. The present invention does not limit the arrangement manner of the antenna unit.

In some embodiments, the antenna structure 2 may include four, six, eight or ten antenna units, and the present invention does not limit the number of antenna units. In some embodiments where four antenna units are included, two antenna units are arranged on one surface of the antenna structure 2, and the other two antenna units are arranged on the other surface of the antenna structure 2.

In this embodiment, eight antenna units (for example: 20A, 20B, 20C, 20D and other four antenna units) are included as an example for description. The antenna units 20A, 20B, 20C, and 20D may be disposed on at least one surface of the antenna structure 2, and four other antenna units (not shown) corresponding to the antenna units 20A, 20B, 20C, and 20D may be disposed on the other surface of the antenna structure 2, and the antenna units 20A, 20B, 20C, and 20D form a dipole antenna with the four other corresponding antenna units respectively. For example, the antenna units 20A, 20B, 20C, and 20D are arranged on an upper surface of the antenna structure 2, while the other four antenna units are arranged on a lower surface of the antenna structure 2.

Specifically, each of the antenna units 20A, 20B, 20C, and 20D may include an extension portion (200A, 200B, 200C, 200D) and a radiation portion (210A, 210B, 210C, 210D). The extension portions 200A, 200B, 200C, and 200D may may extend symmetrically toward an external direction (i.e., the four arrows around the central region CR) from a central region CR around the feed point FP (i.e., the dashed line surrounding the feed point FP), the extension portions 200A, 200B, 200C, and 200D respectively form a rotation corner θ1 (for example, but not limited to 90 degrees) with the radiating portions 210A, 210B, 210C, and 210D, and the radiating portions 210A, 210B, 210C, and 210D extends toward a side relative to the external direction.

In addition, the extension portion 200B of the antenna unit 20B may include an inner section 201b and an outer section 203b, the inner section 201b forms an included angle θ2 with the external direction, and the outer section 203b is parallel to the external direction. That is, the extension portion 200B of the antenna unit 20B forms an included angle θ2 with the external direction, the extension portion 200D of the antenna unit 20D corresponding to the antenna unit 20B is parallel to the external direction, and the antenna unit 20B and the antenna unit 20D are not symmetrical to each other. In some embodiments, the included angle θ2 may range from 15 degrees and 75 degrees. It should be noted that any one of the other four antenna units on the other surface of the antenna structure 2 may be arranged to form an included angle θ2 with the external direction corresponding to configurations of the antenna units 20A, 20B, 20C, and 20D, or may be arranged to form no included angle θ2 with the external direction.

As shown in FIG. 4, the antenna unit 20B and the antenna unit 20D are not symmetrical to each other, the current of the antenna unit 20B flows from the radiation portion 210B through the outer section 203b and the inner section 201b of the extension portion to the feed point FP, the current of the antenna unit 20D correspondingly flows from the radiation portion 210D through the extension portion 200D to the feed point FP. Therefore, the above-mentioned asymmetric structure of the antenna structure 2 prevents the currents between the antenna units 20A, 20B, 20C, and 20D from flowing perpendicular to each other and symmetrically collected at the feed point FP. Therefore, the antenna structure 2 can generate a radiation pattern that is asymmetrical with respect to the feed point FP, thereby causing the depressed null-point Null of the radiation pattern shift to the right of the feed point FP, and preventing the radiated energy in the central region CR of the radiation pattern from significantly canceling each other out. In addition, by shifting the null-point Null of the radiation pattern, a better return loss can be garnered compared to the traditional antenna structure.

For example, the antenna units 20A, 20B, 20C, and 20D can be respectively disposed on the upper surface of the antenna structure 2 and connected to a positive end of the upper surface of the antenna structure 2. In addition, the other four antenna units can be respectively disposed on the lower surface of the antenna structure 2 and connected to a negative end of the lower surface of the antenna structure 2. In another example, the antenna units 20A, 20B, 20C, and 20D can be respectively disposed on the lower surface of the antenna structure 2 and connected to the negative end of the lower surface of the antenna structure 2, and the other four antenna units can be respectively disposed on the upper surface of the antenna structure 2 and connected to the positive end of the upper surface of the antenna structure 2.

In some embodiments, the length of the dipole antenna (i.e., the antenna units disposed on the upper surface and the lower surface of the antenna structure 2) can be between 0.25λ and 0.75λ (Lambda). Due to length of the dipole antenna, the antenna structure 2 can produce a better radiation effect, but the present invention is not limited thereto.

In some embodiments, the antenna structure 2 may include an arbitrary antenna unit with an included angle θ2. For example: any one of the antenna unit 20A, the antenna unit 20C, or the antenna unit 20D can be configured with an included angle θ2.

In some embodiments, the antenna structure 2 may include a plurality of switching units respectively coupled to the extension portions 200A, 200B, 200C, and 200D of the antenna units 20A, 20B, 20C, and 20D. The switching units may selectively turn off a few of the antenna units 20A, 20B, 20C, and 20D. For example, a user can turn off the antenna unit 20B through the switching unit, such that the current of the antenna unit 20B will not flow back to the feed point FP from the radiation portion 210B through the outer section 203b and the inner section 201b of the extension portion 200B. In this case, since the antenna unit 20B and the antenna unit 20D have asymmetric current directions, the currents of the antenna units 20A, 20B, 20C, and 20D will not flow symmetrically and converge perpendicularly with each other at the feed point FP. Therefore, similarly, the antenna structure 2 can generate a radiation pattern that is asymmetrical with respect to the feed point FP.

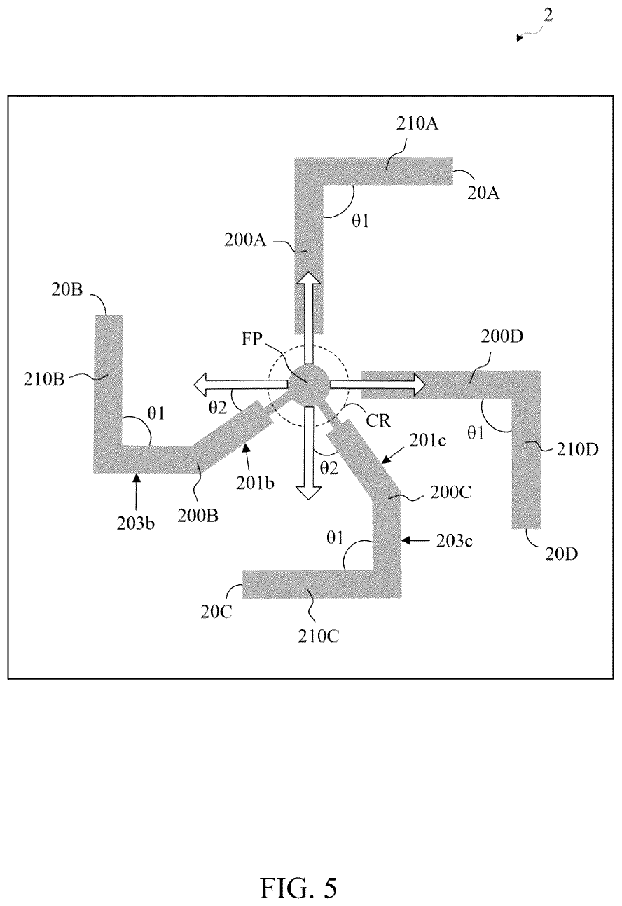

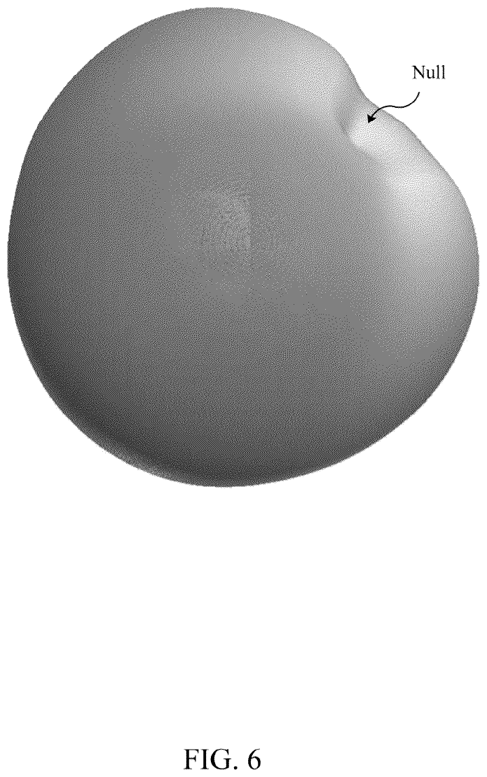

FIG. 5 illustrates a schematic view of an antenna structure 2 with two antenna units having an included angle, according to certain embodiments of the present invention. FIG. 6 illustrates a schematic view of the radiation pattern of an antenna structure 2 with the two antenna units, having the included angle, according to certain embodiments of the present invention. However, the content shown in FIG. 5 and FIG. 6 only illustrates the embodiments of the present invention and should not be interpreted as any limitation on the present invention.

Please refer to FIG. 5. In some embodiments, the extension portions 200B and 200C of the antenna units 20B and 20C each include an inner section 201b, 201c and an outer section 203b, 203c, the inner sections 201b, 201c have an included angle θ2 with the external direction, and the external sections 203b, 203c are generally parallel to the external direction. As mentioned above, the included angle θ2 of the antenna units 20B and 20C may range from 15 degrees to 75 degrees. As shown in FIG. 6, the antenna unit 20B and the antenna unit 20D are not symmetrical to each other, and the antenna unit 20A and the antenna unit 20C are not symmetrical to each other. With the above-mentioned asymmetric structure of the antenna structure 2, the currents of the antenna units 20A, 20B, 20C, and 20D can be prevented from flowing perpendicular to each other and symmetrically collected at the feed point FP. Therefore, the antenna structure 2 can generate a radiation pattern that is asymmetrical with respect to the feed point FP, thereby causing the null-point Null of the radiation pattern to shift toward the upper-right side of the feed point FP.

In some embodiments, any two of the antenna units of the antenna structure 2 may be configured with the included angle θ2. For example, it can be the group of the antenna units 20A and 20B, the antenna units 20A and 20D, or the antenna units 20C and 20D of the antenna structure 2 to be configured with the included angle θ2, but the present invention is not limited thereto. In addition, the included angles θ2 of the two antenna units of the antenna structure 2 can each be different angles ranging from 15 degrees to 75 degrees.

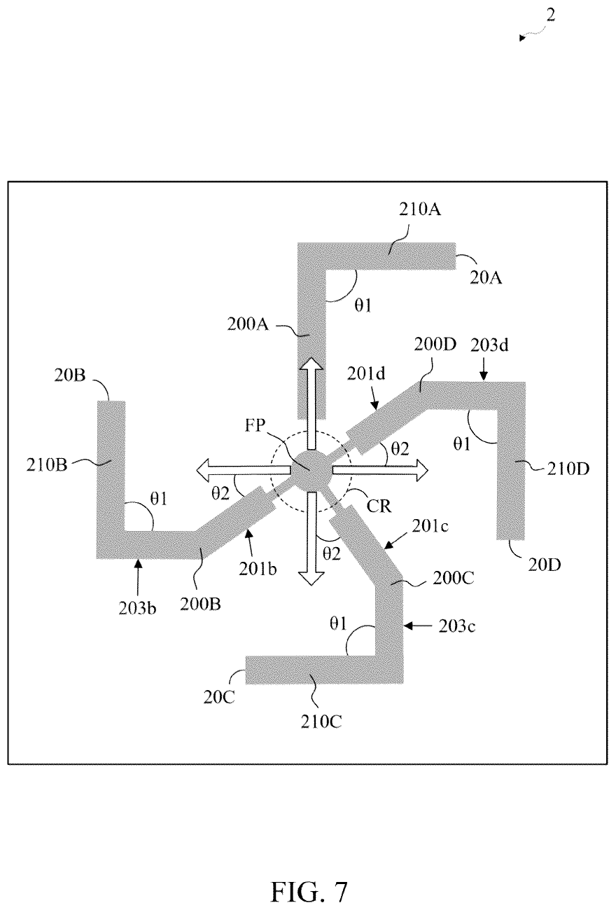

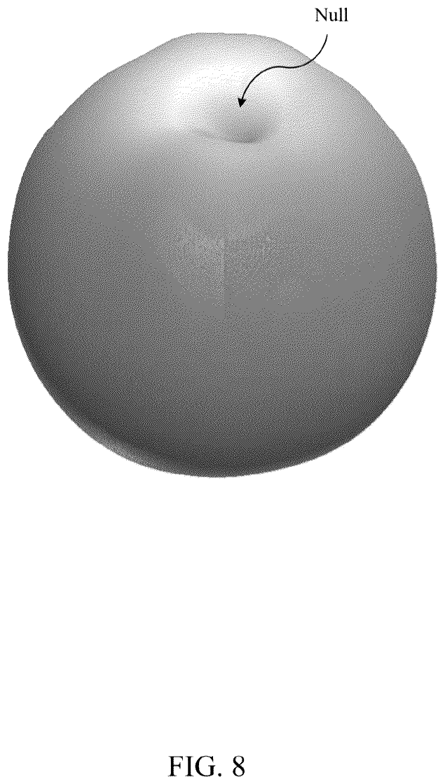

FIG. 7 illustrates a schematic view of an antenna structure 2 with three antenna units having an included angle, according to certain embodiments of the present invention. FIG. 8 illustrates a schematic view of the radiation pattern of an antenna structure 2 with three antenna units having the included angle, according to certain embodiments of the present invention. However, the content shown in FIG. 7 and FIG. 8 is only provided to illustrate the embodiments of the present invention and should not be interpreted as any limitation on the present invention.

Please refer to FIG. 7. In some embodiments, the extension portions 200B, 200C, and 200D of the antenna units 20B, 20C, and 20D each include an inner section 201b, 201c, 201d and an outer section 203b, 203c, 203d, and the inner sections 201b, 201c, 201d each have an included angle θ2 with the external direction respectively. The outer section 203b, 203c, and 203d are generally parallel to the external direction. As mentioned above, the included angle θ2 of the antenna units 20B, 20C, and 20D may range from 15 degrees and 75 degrees. As shown in FIG. 8, the antenna unit 20A and the antenna unit 20C are not symmetrical to each other. The antenna unit 20B and the antenna unit 20D have an asymmetric structure to each other, and the currents of the antenna unit 20B and the antenna unit 20D do not flow perpendicularly and symmetrically collected at the feed point FP. With the above-mentioned asymmetric structure of the antenna structure 2, the currents of the antenna units 20A, 20B, 20C, and 20D can be prevented from flowing perpendicular to each other and symmetrically collected at the feed point FP. Therefore, the antenna structure 2 can generate a radiation pattern that is asymmetrical with respect to the feed point FP, thereby causing the depressed null-point Null of the radiation pattern to shift toward the upper side of the feed point FP.

In addition, in some embodiments, any three antenna units of the antenna structure 2 may be configured with the included angle θ2. For example, it can be the group of antenna units 20A, 20B, and 20C, the antenna units 20A, 20B, and 20D, or the antenna units 20A, 20C, and 20D of the antenna structure 2 to be configured with the included angle θ2, but the present invention is not limited thereto. In addition, the three included angles θ2 of the three antenna units of the antenna structure 2 can each be different angles ranging from 15 degrees to 75 degrees.

In some embodiments, the antenna unit in the antenna structure 2 of the present invention can be implemented using different manufacturing methods, such as but not limited to, printed circuit board process, flexible printed circuit board process, or means of laser direct structuring. The above-mentioned manufacturing method can enable a more flexible design for the antenna unit and adjust the antenna structure 2 to more suitable usage requirements.

In some embodiments, the antenna structure 2 of the present invention can also include a metal reflector, which can be disposed below the antenna units or above the antenna units. In addition, in some embodiments, the metal bottom shell of the antenna device can be used as the metal reflector.

In some embodiments, the extension portions 200A, 200B, 200C, and 200D and the radiating portions 210A, 210B, 210C, and 210D of the antenna structure 2 forming the angle θ2 may be arranged in a clockwise structure. In addition, in some embodiments, the extending portions 200A, 200B, 200C, and 200D and the radiating portions 210A, 210B, 210C, and 210D may also be arranged in a counterclockwise structure. Regardless of the clockwise structure or the counterclockwise structure, the arrangements are configured to shift the depressed null-point Null of the radiation patterns and generate a better return loss, compared to arrangements of the traditional antenna structures.

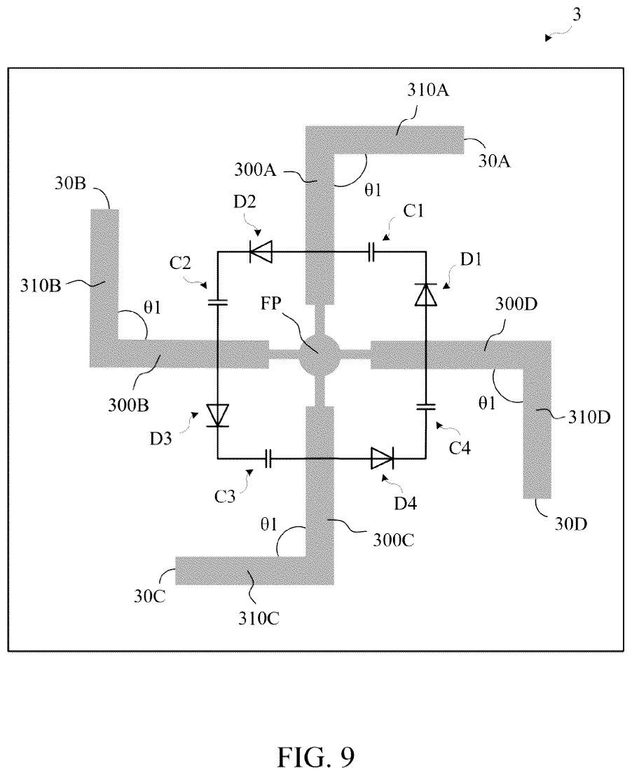

FIG. 9 illustrates a schematic view of an antenna structure 3 with a switching unit according to certain embodiments of the present invention, but the content shown in FIG. 9 is only provided to illustrate the embodiment of the present invention and should not be interpreted as any limitation to the present invention.

As shown in FIG. 9, the structures of the antenna structure 3 and the antenna structure 2 are generally the same, and the difference between the two is that the antenna structure 3 can include antenna units without the included angle θ2, and a few of the antenna units 30A, 30B, 30C, and 30D can be turned off by the switching units. Specifically, the antenna structure 3 may include a ground terminal G, a feed point FP, a plurality of antenna units (for example: 30A, 30B, 30C, 30D) and a plurality of switching units.

Specifically, the antenna units 30A, 30B, 30C, and 30D may include an extension portion (300A, 300B, 300C, 300D) and a radiation portion (310A, 310B, 310C, 310D), respectively. The extension portions 300A, 300B, 300C, and 300D may symmetrically extend from the central region CR around the feed point FP (i.e., the dashed line around the feed point FP) toward the external direction (i.e., the four arrows around the central region CR), the extension portions 300A, 300B, 300C, and 300D respectively form a rotation corner θ1 (for example, but not limited to 90 degrees) with the radiating portions 310A, 310B, 310C, and 310D, and the radiating portions 310A, 310B, 310C, and 310D extend to one side relative to the external direction.

The user can turn off a few of the antenna units 30A, 30B, 30C, and 30D through the switching units, so that the antenna units 30A, 30B, 30C, and 30D form asymmetric current directions with each other. In this case, the currents of the antenna units 30A, 30B, 30C, and 30D can be prevented from flowing perpendicular to each other and symmetrically collected at the feed point FP. Therefore, the antenna structure 3 can generate an asymmetrical radiation pattern relative to the feed point FP, thereby shifting the depressed null-point Null of the radiation pattern and producing a better return loss compared to a traditional antenna structure.

In some embodiments, the antenna structure 3 may be designed to have an annular closed loop, and the switching units may be disposed in the annular closed loop. In some other embodiments, each of the switching units may include a diode (i.e., D1, D2, D3, D4) to switch on and off with the switching units and control the current path of the annular closed loop. In addition, each switching unit may also include a capacitor (i.e., C1, C2, C3, C4) to block the passage of direct current to avoid short circuiting the annular closed loop caused by the voltage of the direct current.

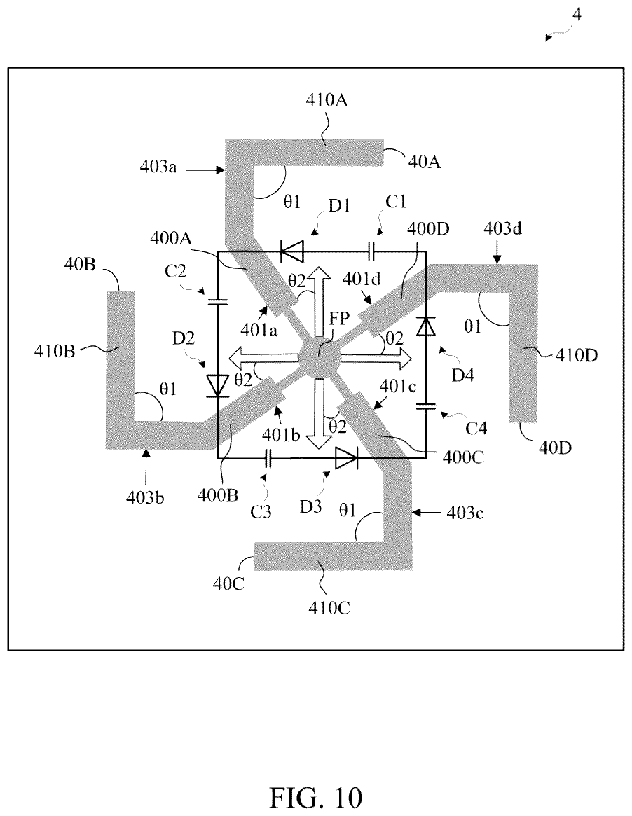

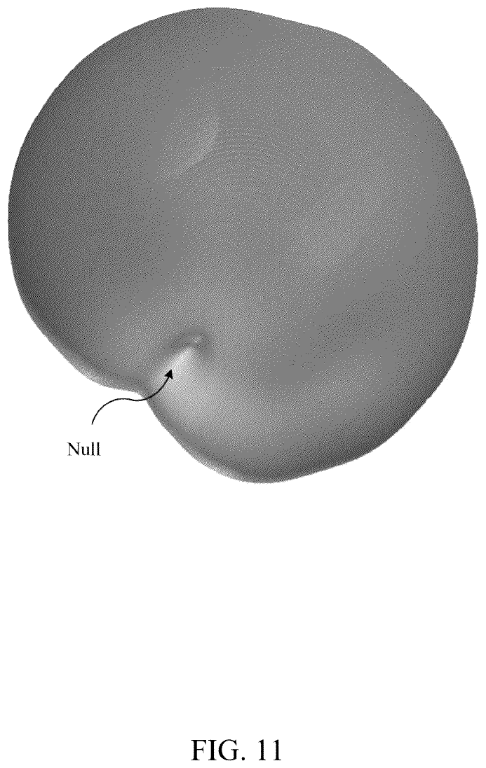

FIG. 10 illustrates a schematic view of an antenna structure 4 with a switching unit according to certain other embodiments of the present invention. FIG. 11 illustrates a schematic view of the radiation pattern of an antenna structure 4 with a switching unit according to certain other embodiments of the present invention. However, the content shown in FIG. 10 and FIG. 11 is only provided to illustrate embodiments of the present invention and should not be interpreted as any limitation to the present invention.

As shown in FIG. 10, the structure of the antenna structure 4 is generally the same as that of the antenna structure 3. The antenna units 40A, 40B, 40C, and 40D may include an extension portion (i.e., 400A, 400B, 400C, 400D) and a radiation portion (i.e., 410A, 410B, 410C, 410D), respectively. The difference from the antenna structure 3 is that the extension portions of at least one antenna unit of the antenna structure 4 may each include an inner section and an outer section, and the inner section may form an included angle θ2 with the external direction.

For example, the extension portions 400A, 400B, 400C, and 400D of the four antenna units of the antenna structure 4 may include an inner section 401a, 401b, 401c, 401d and an outer section 403a, 403b, 403c, 403d, respectively, the inner sections 401a, 401b, 401c, and 401d may each form an included angle θ2 with the external direction, and the outer sections 403a, 403b, 403c, 403d are all generally parallel to the external direction.

It should be noted that the present invention does not limit the number of antenna units having the included angle θ2. In some embodiments, the antenna structure 4 may include two, three or four antenna units with the included angle θ2, and the included angles θ2 may be different angles ranging from 15 degrees to 75 degrees. It should be noted that the present invention does not limit the number of antenna units to be turned off through switching units. For example, the user can turn off the antenna unit 40C through the switching unit, such that the current of the antenna unit 40C does not flow back to the feed point FP from the radiation portion 410C through the extension portion 400C.

In addition, please refer to FIG. 11, the antenna unit 40C and the antenna unit 40A may have asymmetric current directions with each other. In this case, the currents of the antenna units 40A, 40B, 40C, and 40D can be prevented from flowing perpendicular to each other and symmetrically collected at the feed point FP. Therefore, the antenna structure 4 can generate a radiation pattern that is asymmetrical with respect to the feed point FP, thereby shifting the depressed null-point Null of the radiation pattern and producing a better return loss compared to the traditional antenna structure.

In some embodiments, the antenna structure 2, 3 or 4 can receive a signal sent by a terminal device of the user to determine the user's location and the signal strength of the terminal device. When the antenna structure 2, 3 or 4 determines the signal strength of the terminal device to be too weak, it can selectively turn off the antenna unit(s) in the antenna structure 2 through the switching unit, thereby causing the antenna structure 2 to generate an asymmetrical radiation pattern, and improving communication quality and stability to meet the needs of the user. Based on the foregoing description, an artisan having ordinary skill in the art should easily understand how to implement the operation of this embodiment, and further description is omitted.

The above embodiments are only examples for illustrating the present invention, and are not intended to limit the scope of the present invention. Any other embodiments produced by modifying, changing, adjusting, or integrating the above-mentioned embodiments shall be substantially covered in the scope claimed in the present invention as long as they are not difficult for a person having ordinary skill in the art to contemplate. The scope of the present invention shall be determined by the claims as listed.

1. An antenna structure, comprising:
a ground terminal;
a feed point disposed in a central region of the antenna structure; and
a plurality of antenna units disposed on at least one surface of the antenna structure respectively, wherein each of the plurality of antenna units comprises an extension portion and a radiation portion, the extension portions extend symmetrically toward an external direction from the central region, the extension portions form a corner with their corresponding radiation portions respectively, and the radiation portions extend toward a side relative to the external direction.
wherein a few of the extension portions comprise an inner section and an outer section, the inner section forms an included angle with the external direction, and the outer section is parallel to the external direction, and the antenna structure generates a radiation pattern asymmetrical with respect to the feed point.

2. The antenna structure of claim 1, wherein the plurality of antenna units further comprises a plurality of switching units coupled to each of the extension portions of the antenna units respectively, the plurality of switching units is configured to selectively turn off a few of the antenna units.

3. The antenna structure of claim 2, wherein each of the switching units further comprises a diode.

4. The antenna structure of claim 3, wherein each of the switching units further comprises a capacitor.

5. The antenna structure of claim 1, wherein the antenna units are disposed on an upper surface and a lower surface of the antenna structure to form a dipole antenna.

6. The antenna structure of claim 5, wherein the length of the dipole antennas is between 0.25λ and 0.75λ.

7. The antenna structure of claim 1, wherein the included angle of the extension portion is between 15 degrees and 75 degrees.

8. The antenna structure of claim 1, wherein the radiation portions of the antenna units are arranged in either a clockwise structure or a counterclockwise structure.

9. The antenna structure of claim 1, wherein the antenna units are formed by a printed circuit board process, a flexible printed circuit board process, or formed by laser direct structuring.

10. The antenna structure of claim 1, further comprising a metal reflector disposed below or above the antenna units.

11. An antenna structure, comprising:
a ground terminal;
a feed point disposed at a central region of the antenna structure;
a plurality of antenna units disposed on at least one surface of the antenna structure, wherein each of the plurality of antenna units comprises an extension portion and a radiation portion, the extension portions extend symmetrically toward an external direction from the central region, the extension portions form a corner with their corresponding radiation portions, respectively, and the radiation portions extend toward a side relative to the external direction; and
a plurality of switching units coupled to the extension portions of the antenna units, respectively, and configured to selectively turn off a few of the antenna units to generate a radiation pattern asymmetrical with respect to the feed point.

12. The antenna structure of claim 11, wherein the extension portion of the at least one antenna unit comprises an inner section and an outer section, the inner section forms an included angle with the external direction, and the outer section is parallel to the external direction.

13. The antenna structure of claim 11, wherein each of the switching units further comprises a diode.

14. The antenna structure of claim 13, wherein each of the switching units further comprises a capacitor.

15. The antenna structure of claim 11, wherein the antenna units are disposed on an upper surface and a lower surface of the antenna structure to form a dipole antenna.

16. The antenna structure of claim 15, wherein the length of the dipole antennas is between 0.25λ and 0.75λ.

17. The antenna structure of claim 11, wherein the switching units selectively turn off the few of the antenna units based on a signal location of a terminal equipment.

18. The antenna structure of claim 11, wherein the radiation portions of the antenna units are arranged in either a clockwise or a counterclockwise structure.

19. The antenna structure of claim 11, wherein the antenna units are formed by a printed circuit board process, a flexible printed circuit board process, or formed by laser direct structuring.

20. The antenna structure of claim 11, further comprising a metal reflector disposed below or above the antenna units.
